(19) United States
(12) Patent Application Publication
(10) Pub. No.: US 2012/0147381 A1
(43) Pub. Date: Jun. 14, 2012

(54) Optical Fiber Reflective Sensor Interrogation Device

(76) Inventors: Michel Joseph LeBlanc, Houston, TX (US); Etienne Marcel Samson, Houston, TX (US)

(21) Appl. No.: 13/391,150

(22) PCT Filed: Aug. 20, 2009
(86) PCT No.: PCT/US09/54391

§ 371 Date: Feb. 17, 2012

(51) Int. Cl. G01N 21/55; G02B 6/32; G01B 9/02

(52) U.S. Cl. 356/480; 356/445; 385/33; 65/387

(57) ABSTRACT

A system includes an optical source. The system further includes a reflective sensor remotely deployed from the optical source. The system further includes an optical processor. The system further includes a forward optical waveguide spanning the distance from, and transmitting light from, the optical source to the reflective sensor. The system further includes a return optical waveguide spanning the distance from, and transmitting light from, the reflective sensor to the optical processor. The forward optical waveguide follows substantially the same path as, but is completely separate from, the return optical waveguide.

### BACKGROUND

Downhole oil field equipment sometimes operates under great pressures and temperatures. Reflective sensors, i.e., sensors that are interrogated by reflecting light from the sensors, are sometimes useful in such situations because they may not include temperature-sensitive electronics. Fiber optics are sometimes used to carry the light used to interrogate the reflective sensors.

### BRIEF DESCRIPTION OF THE DRAWINGS

FIG. 1 is a schematic diagram of a completed well.

FIG. 2 is a schematic of a wireline logging system.

FIG. 3 is a schematic diagram of a drilling rig site showing a logging tool that is suspended from a wireline and disposed internally of a bore hole.

FIG. 4 illustrates a prior art reflective sensor interrogating system.

FIG. 5 illustrates an optical coupler.

FIG. 6 illustrates a prior art reflective sensor interrogating system.

FIGS. 7 and 8 illustrate optical fiber reflective sensor interrogation devices.

FIGS. 9-11 illustrate the interface between optical fiber reflective sensor interrogation devices and reflective sensors.

FIG. 12 illustrates a remote real time operating center.

### DETAILED DESCRIPTION

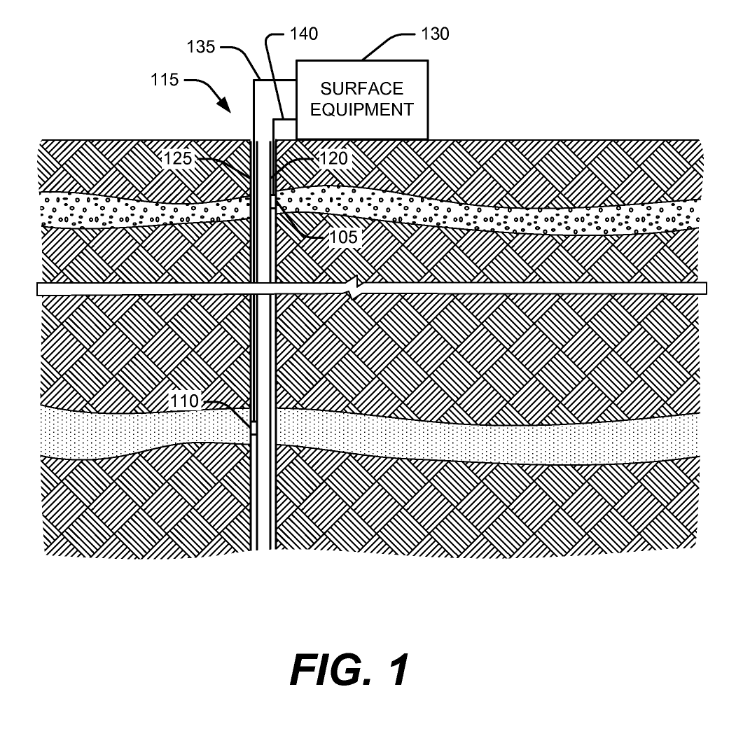

In one embodiment, illustrated in FIG. 1, sensors 105 and 110 are located in a completed well bore 115 between a casing 120 and a well bore wall 125. In one embodiment (not shown), the completed well includes production tubing inside the casing 120 and the sensors 105 and 110 are between the casing 120 and the well tubing. In one embodiment, surface equipment 130 is provided to process information from the sensors 105 and 110. In one embodiment, communications media 135 and 140 are used to interrogate the sensors 105 and 110 and to carry the resulting information to the surface equipment 130. In one embodiment, communications media 135 and 140 are optical waveguides. In one embodiment, communications media 135 and 140 are optical fibers. In one embodiment, communications media 135 and 140 are a combination of wires and optical fibers, with the wires carrying information part of the distance from the sensors 105 and 110 to the surface equipment 130 and the optical fibers carrying the information part of the distance. In one embodiment, each fiber 105 and 110 is dedicated to carrying information from a single sensor 105 or 110. In one embodiment, each fiber 105 and 110 carries information from a plurality of sensors. In one embodiment, each communications media 135 and 140 is a single optical fiber. In one embodiment, each communications media comprises a plurality of optical fibers. In one embodiment, the communications media 135 and 140 comprise a single-mode optical fiber. In one embodiment, the communications media 135 and 140 comprises a multi-mode optical fiber.

In one embodiment, the sensors 105 and 110 are Fabry-Pérot sensors. In one embodiment, the sensors 105 and 110 are used to measure temperature, pressure, position, index of refraction of a medium, acceleration, vibration, seismic energy, or acoustic energy.

FIG. 1 is a greatly simplified illustration of a completed well. Many features of typical completed wells, such as the well head equipment, have been omitted from the drawing for illustrative purposes.

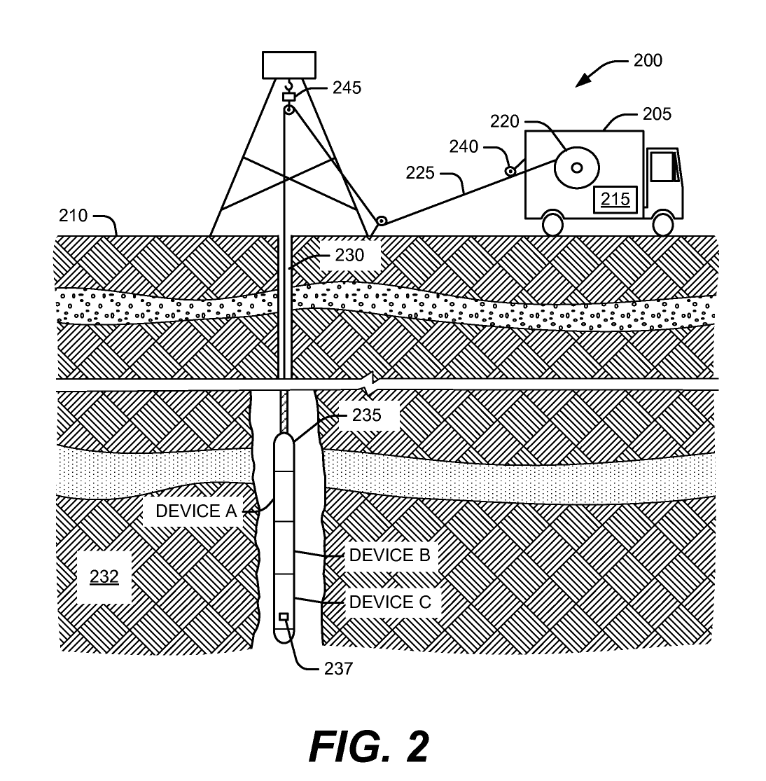

In one embodiment of a wireline well logging system 200 at a drilling rig site, as depicted in FIG. 2, a logging truck or skid 205 on the earth's surface 210 houses a data gathering computer 215 and a winch 220 from which a wireline cable 225 extends into a well bore 230 drilled into a hydrocarbon bearing formation 232. In one embodiment, the wireline cable 225 suspends a logging toolstring 235 within the well bore 230 to measure formation data as the logging tool 235 is raised or lowered by the wireline 225. In one embodiment, the logging toolstring 235 includes a z-axis accelerometer 237 and several devices A, B, C. In different embodiment, these devices are instruments, mechanical devices, explosive devices, and/or sensors of the type described above (e.g., Fabry-Pérot sensors).

In one embodiment, the wireline cable 225 not only conveys the logging toolstring 235 into the well, it also provides a link for power and communications between the surface equipment and the logging toolstring.

In one embodiment, as the logging tool 235 is raised or lowered within the well bore 230, a depth encoder 240 provides a measured depth of the extended cable. In one embodiment, a tension load cell 245 measures tension in the wireline 225 at the surface 210.

In one embodiment, the wireline cable 225 includes one or more optical fibers for interrogating one or more of devices A, B or C.

FIG. 2 is a greatly simplified illustration of a wireline operation. Many details of such an operation have been omitted from the drawing for illustrative purposes.

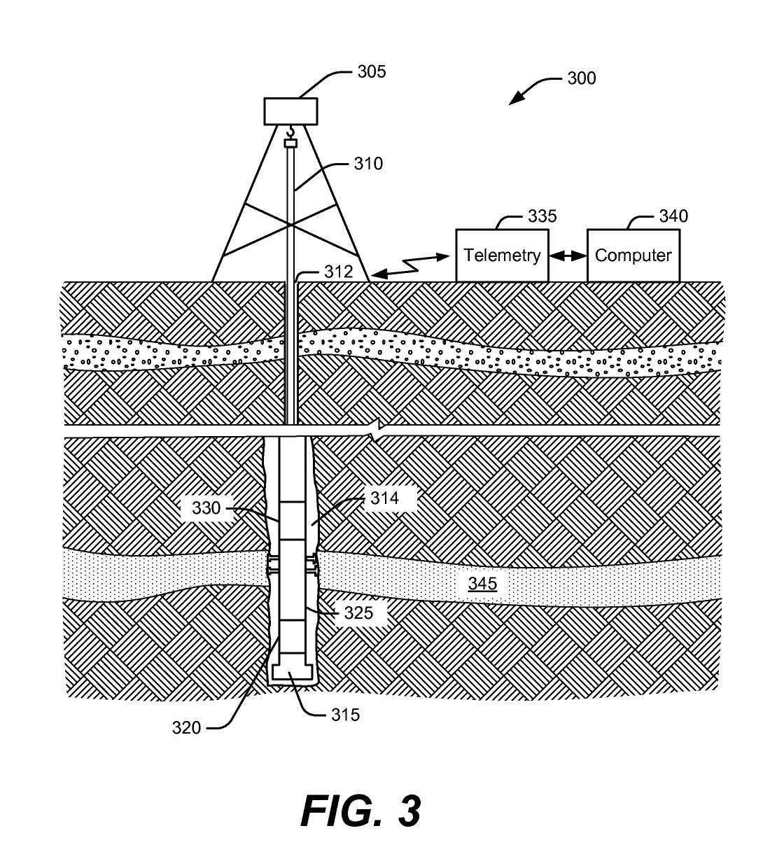

In one embodiment of a measurement while drilling (“MWD”) or logging while drilling (“LWD”) environment 300, illustrated in FIG. 3, a derrick 305 suspends a drill string 310 in a borehole 312. In one embodiment, the volume within the borehole 312 around the drill string 310 is called the annulus 314. In one embodiment, the drill string includes a bit 315, a variety of actuators and sensors, shown schematically by element 320, an instrument 325 (such as, for example, a formation testing instrument, an acoustic sensor, a resistivity tool, or the like), and a telemetry section 330, through which the downhole equipment communicates with a surface telemetry system 335. In one embodiment, a computer 340, which in one embodiment includes input/output devices, memory, storage, and network communication equipment, including equipment necessary to connect to the Internet, receives data from the downhole equipment and sends commands to the downhole equipment.

In one embodiment, element 320 includes sensors of the type described above (e.g., Fabry-Pérot sensors). In one embodiment, communications media (not shown) extend from the element 320 to surface equipment (not shown) where the information from the sensors is processed. In one embodiment, the communications media includes an optical fiber that is used to interrogate element 320. In one embodiment, an optical fiber extends from element 320 to another element in the drill string 310 where information from the optical fiber is incorporated into telemetry data that is sent to the surface telemetry section. In one embodiment, an optical slip ring (not shown) is included to accommodate the transition of the optical fiber from non-rotating parts of the system to rotating parts of the system.

FIG. 3 is greatly simplified and for clarity does not show many of the elements that are used in the drilling process.

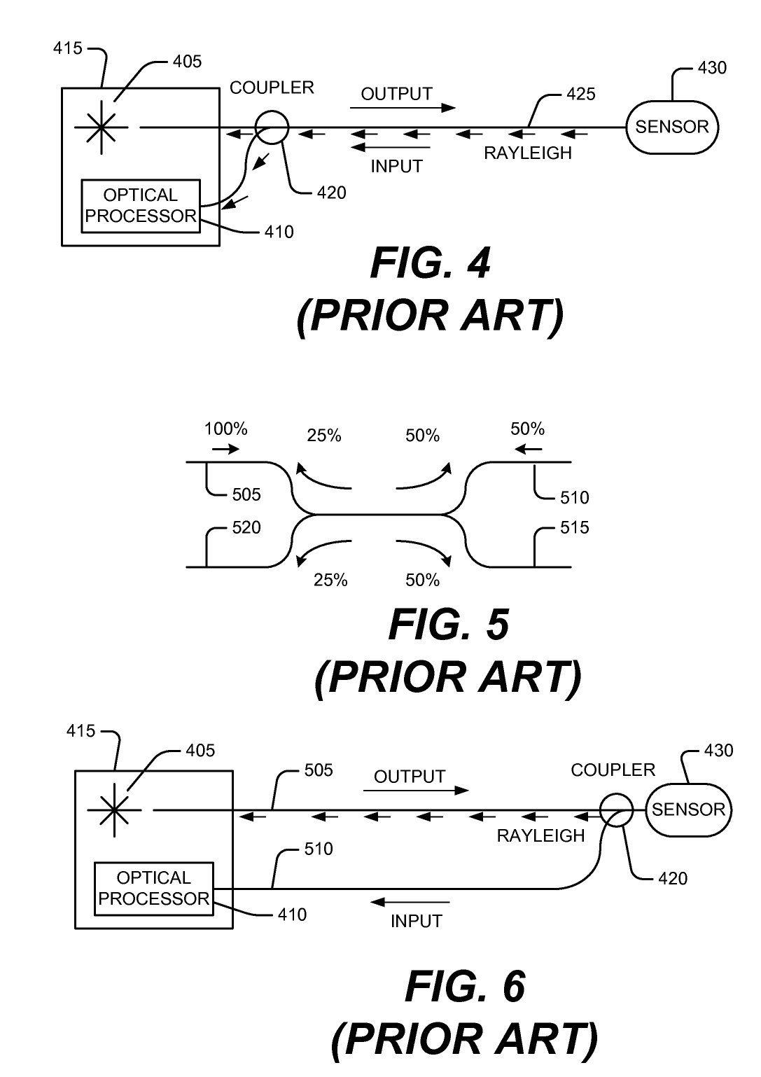

FIG. 4 shows a prior art method to interrogate a reflective sensor through an optical fiber using a coupler. A light source 405 and an optical processor 410 are typically housed within a housing 415. Fiber optic cables couple the light source 405 and the optical processor to respective ports on a coupler 420. A third port on the coupler 420 is coupled to a fiber optic cable 425 which carries light from the light source 405 to a reflective sensor 430. The same fiber optic cable 425 carries reflected light from the sensor 430 to the coupler and then to the optical processor 410.

An example coupler, illustrated in FIG. 5, has four ports. In the example system shown in FIG. 4, the first port 505 receives light from the light source 405. That light is split with half exiting the second port 510 and half exiting the third port 515. The half exiting the third port is delivered to a device that absorbs the light in order to minimize reflections back into the system. In the system illustrated in FIG. 4, the half exiting the second port is transmitted to the sensor 430 where it is reflected and returned to the second port 510. The coupler splits the returned light, with half exiting the first port 505 and half exiting the fourth port 520. Thus, ignoring all other losses, 25 percent of the light transmitted from the light source 405 to the coupler 420 is returned to the optical processor 410.

In some prior art systems using single mode optical fibers, a circulator is used instead of a coupler. Rather than the 6 to 7 dB loss exhibited by the coupler, the circulator will introduce approximately a 1 dB loss.

For long lengths of fiber optic cable 425, the approach illustrated in FIG. 4 results in a large proportion of the light returned to the coupler 420 being contributed by the Rayleigh backscattering of the launched light, illustrated by the word “Rayleigh” on FIG. 4. This backscattering does not contain any information useful in the measurement and its presence decreases the signal-to-noise ratio at the optical processor 410. An illustration of the Rayleigh backscatter effect is the effect of looking at a road while driving on a foggy night with the vehicle high beams on. The backscattered light from the fog overwhelms the view of everything except the closest objects.

FIG. 6 shows a prior art approach that reduces the backscattering detected and therefore provides an improvement over the approach of FIG. 4. The difference is the location of the coupler 420, which is close to the sensor in FIG. 6. Further, two optical fibers are used: a first optical fiber 505 carries the light from the light source 405 to the coupler 420 and a second optical fiber 510 carries the reflected light from the coupler 420 to the optical processor 410. Only a very short length of fiber (between the coupler and the sensor) contributes backscattering in the system of FIG. 5. This reduction of backscattering allows longer fiber lengths to be used and therefore permits the reach for the sensor system to be extended. This is highly desirable for monitoring deep oil wells, for example.

The use of the terms “input” and “output” with respect to the system depicted in FIG. 6 is relative to the housing 415 containing the light source 405 and the optical processor 410. That is, the output optical fiber 505 carries the output of the light source 405 and the input optical fiber 510 carries the input to the optical processor 410. This convention will be followed in describing the remaining figures in this application.

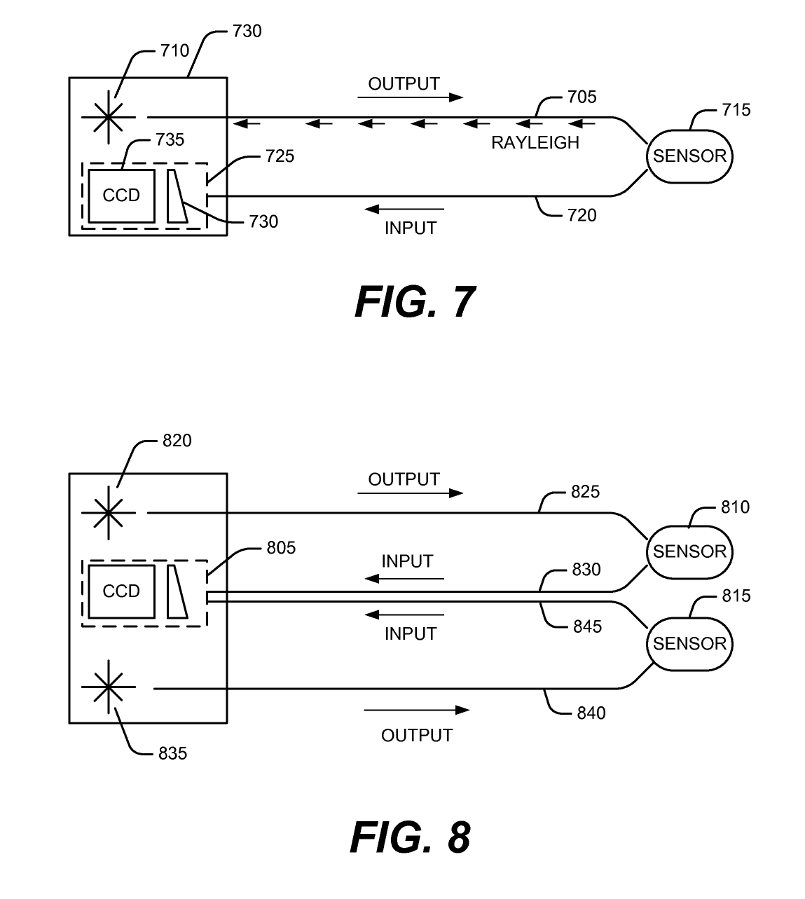

One embodiment of an optical fiber reflective sensor interrogation system, illustrated in FIG. 7, eliminates the coupler (or the circulator) by employing an output optical fiber 705 that spans the distance from a light source 710 to the reflective sensor 715 and an input optical fiber 720 that spans the distance from the sensor 715 to an optical processor 725. In one embodiment, light from the light source 710 is brought directly to the sensor by the output optical fiber 705. In one embodiment, the light source 710 is located downhole close to the location of the sensor. In one embodiment, the input optical fiber 720 is placed in close proximity to the output optical fiber 705 and is oriented relative to the output optical fiber and the sensor so that the light that is reflected by the reflective sensor 715, which is encoded by a transduction mechanism of the reflective sensor, is reflected primarily into the input optical fiber 720. The reflected light is returned by the input optical fiber 720 to the optical processor 725.

Note that a housing 730 that includes the light source 710 and the optical processor 725 may include one or more optical fibers that extend from the light source 710 to a connector accessible from the outside of the housing 730 and one or more optical fibers that extend from a connector accessible from the outside of the housing 730 to the optical processor 725. In that case, the output optical fiber 705 and input optical fiber 720 are considered to span the distance between the light source 710 and the sensor 715 and between the sensor 715 and the optical processor 725 if they span the distance between the connectors accessible from the outside of the housing 730 to the sensor 715. Further, an optical fiber is considered to span a distance even if the optical fiber is spliced in that distance.

In one embodiment, the light source 710 is a source of broadband white light, i.e., light that covers a broad spectrum. In one embodiment, the light source 710 is a light bulb. In one embodiment, the light source 710 is a source of black-body emissions. In one embodiment, the light source 710 is a narrow band source of light. In one embodiment, the light source 710 is a laser. In one embodiment, the light source 710 is a Light Emitting Diode (“LED”). In one embodiment, the light source 710 is a supercontinuum light source.

In one embodiment, the optical processor includes a wedge 730 and a charge-coupled device (“CCD”) array 735. The wedge focuses the reflected light on a detectable position in the CCD array that is indicative of the property being measured by the reflective sensor 715. In one embodiment, the system shown in FIG. 7 acts as a Fizeau interferometer. In one embodiment, the system shown in FIG. 7 acts as a Fabry-Pérot interferometer.

In one embodiment, the output optical fiber 705 and the input optical fiber 720 are considered to be a “device” with two inputs (one from the light source 710 and one from the sensor 715) and two outputs (one to the sensor 715 and one to the optical processor 725).

In another embodiment, illustrated in FIG. 8, a single optical processor 805, which is similar to the optical processor 725 described above, processes signals from two different sensors 810 and 815. In one embodiment, measurements from one of the sensors are used to compensate measurements from the other sensor. For example, in one embodiment, sensor 810 is a pressure sensor and sensor 815 is a temperature sensor co-located with the pressure sensor 810. In that case, the measurements from the temperature sensor 815 may be used to compensate (i.e., temperature adjust) the measurements from the pressure sensor 810.

In the embodiment shown in FIG. 8, light from a first light source 820 is routed to a first reflective sensor 810 by a first output optical fiber 825. Reflected light from the reflective sensor 810 is routed to the optical processor 805 by a first input optical fiber 830. Light from a second light source 835 is routed to a second reflective sensor 815 by a first output optical fiber 840. Reflected light from the reflective sensor 815 is routed to the optical processor 805 by a second input optical fiber 845. A controller (not shown) selects which input the optical processor 805 processes at any given time.

In one embodiment, the optical fibers 825, 830, 840, and 845 are considered to be a “device” with four inputs (one from each of the light sources 820 and 835 and one from each of the sensors 810 and 815) and four outputs (one from each of the sensors 810 and 815 and two to the optical processor 805).

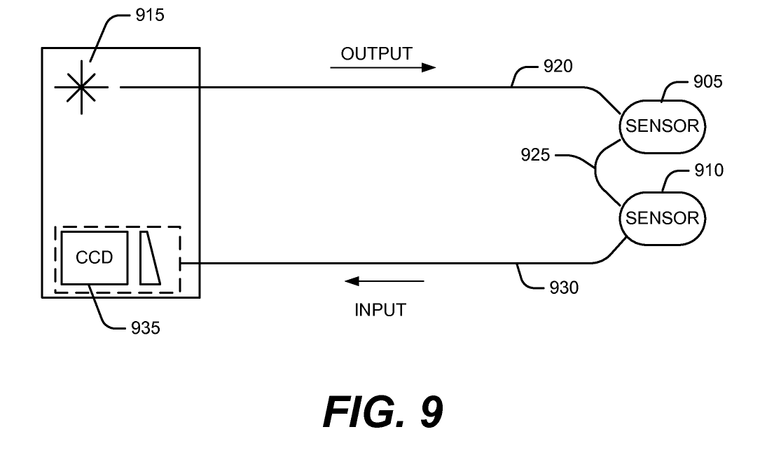

In another embodiment shown in FIG. 9, two sensors 905 and 910 are daisy-chained together. In one embodiment the sensor 905 is remotely deployed (i.e. more than 1 meter) from the sensor 910. A single source of light 915 transmits light over an output optical fiber 920 to a first sensor 905. The reflected light from the first sensor is transmitted over a linking optical fiber 925 to a second sensor 910. The reflected light from the second sensor 910 is transmitted over an input optical fiber 930 to an optical processor 935.

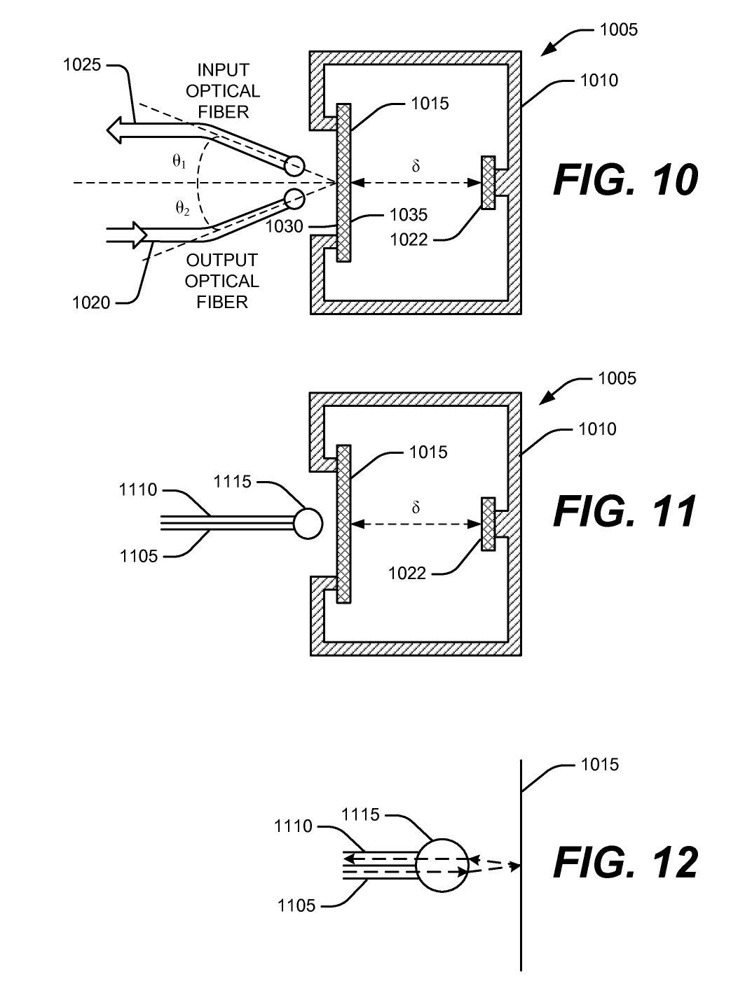

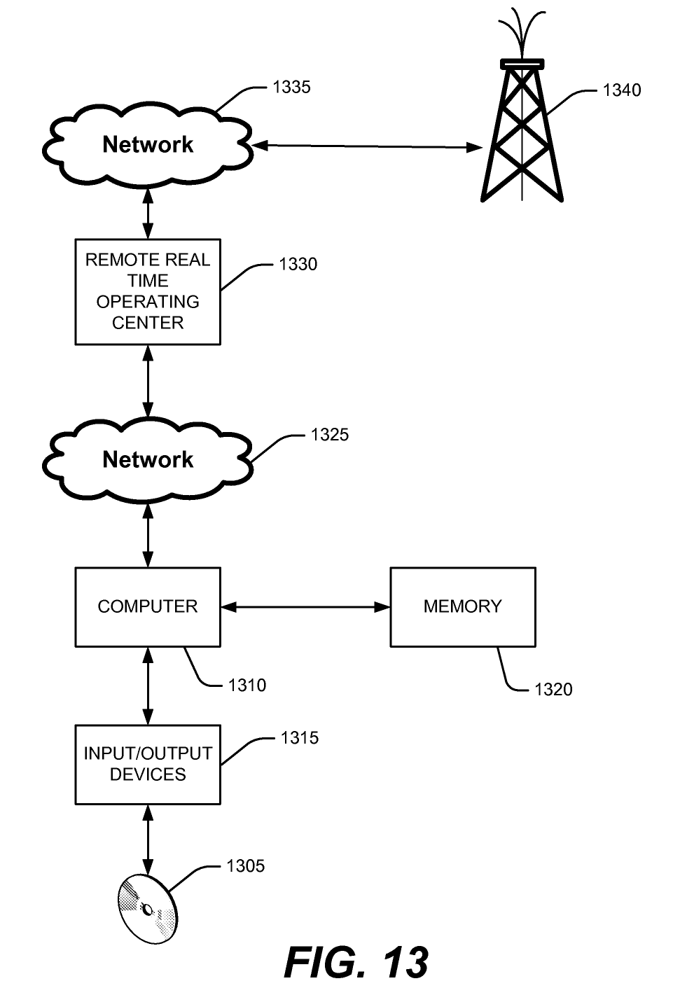

In one embodiment, the sensors 905 and 910 are adjusted so that the returns from the two devices can be distinguished. In particular, in one embodiment, the distance between the window and the mirror (see FIGS. 10 and 11 below) in sensor 905 is different from the distance between the window and the mirror in sensor 910.

In one embodiment, the distance between the window and the mirror in sensor 905 is substantially the same as the distance between the window and the mirror in sensor 910.

In one embodiment, the optical fibers 920, 925, and 930 are considered a “device” with three inputs (one from the light source 915 and one from each of the sensors 905 and 910) and three outputs (one to each of the sensors 905 and 910 and one to the optical processor 935).

In one embodiment of the interface between the optical fibers and the reflective sensor, illustrated in FIG. 10, a reflective sensor 1005 includes a housing 1010, a window 1015, and a mirror 1022. In one embodiment, the distance δ between the window 1015 and the mirror 1022 is predictably influenced by the property being measured. For example, variations in temperature and pressure can cause δ to vary. The round trip distance from the light source to the optical processor (see FIGS. 7 and 8) is, therefore, related to a measure of the property (i.e., the temperature or pressure).

In the embodiment shown in FIG. 10, the output optical fiber 1020 and the input optical fiber 1025 follow approximately parallel paths (i.e., in one embodiment, they are touching along their entire paths or they are within 0.25 of a fiber diameter over their entire paths) until they approach the sensor 1005. At that point they deviate toward each other along paths at angles θ₁ and θ₂ relative to a center line between the two fibers. In one embodiment, θ₁ and θ₂ are between 0 and 45 degrees. In one embodiment (not shown) the fibers deviate away from each other before they deviate toward each other. In one embodiment, θ₁ and θ₂ are between 3 and 12 degrees. In one embodiment, the output optical fiber 1020 and the input optical fiber 1025 are arranged so that light traveling through output optical fiber 1020 reflects from the window 1015 and the mirror 1022, sometimes after multiple reflections between the window 1015 and the mirror 1022, to input optical fiber 1025.

In one embodiment, the window 1015 has two surfaces: a first surface 1030 closest to the output optical fiber 1020 and the input optical fiber 1025, and a second surface 1035. In one embodiment, the first surface 1030 is inclined relative to the second surface 1035 so that the reflection from the first surface 1030 does not reach the input optical fiber 1025. The Fabry-Pérot sensor is therefore limited to the second surface 1035 and the mirror 1022 and is not affected by the first surface 1030.

In one embodiment, the output optical fiber 1020 and input optical fiber 1025 have ball lenses formed at their distal ends, i.e., at their ends closest to the window 1015. In one embodiment, the ball lenses are formed by melting the ends of the fibers using the plasma discharge from an electric arc.

In one embodiment, the ball lenses are located between 0.1 and 2.0 mm from the plate 1015.

In one embodiment, the ball lens at the end of the output optical fiber 1020 is approximately (i.e., within 10 percent) the same size as the ball lens at the end of the input optical fiber 1025. In one embodiment, the diameter of the ball lens at the end of the input optical fiber 1025 is approximately (i.e., +/−10%) 0.5 mm. In one embodiment, the diameter of the ball lens at the end of the output optical fiber 1020 is approximately (i.e., +/−10%) 0.3 mm. In one embodiment, the ratio between the diameter of the ball lens at the end of the output optical fiber 1020 and the diameter of the ball lens at the end of the input optical fiber 1025 is between 0.5 and 1.0. The larger ball on the input side collects more light, which is useful because the light exiting the output side will diverge.

In one embodiment, the numerical aperture of the ball lens at the end of the output optical fiber 1020 (i.e., the angular width of the beam that comes out of the lens) is approximately (i.e., within 10 percent) the same size as the numerical aperture of the ball lens at the end of the input optical fiber 1025 (i.e., the acceptance angle of the lens). In one embodiment, the ratio of the numerical aperture of the ball lens at the end of the output optical fiber 1020 and the numerical aperture of the ball lens at the end of the input optical fiber 1025 is between 0.5 and 1.0.

In one embodiment (not shown), the ball lenses are replaced by traditional collimating lenses separate from the two fibers.

In one embodiment, the lenses are graded index lenses.

In one embodiment, the ends of the output optical fiber 1020 and input optical fiber 1025 are not melted to form balls. Instead, they are cleaved. In one embodiment, the fibers are cleaved or polished along a plane normal to the fiber axis or along a plane angled away from perpendicular to the fiber axis by 6-12 degrees. The latter cleaving arrangement is to avoid back reflection to the source. In one embodiment, the cleaving arrangement is used to orient the beam of light exiting the output optical fiber 1020 toward the sensor and to orient the reception sensitivity of the input optical fiber 1025 toward the sensor while keeping both fibers parallel but separated by a small distance for more compact packaging. In one embodiment, the cleaving arrangement is used with a single lens for both fibers. In one embodiment, the cleaving arrangement is used with a lens for each fiber. In one embodiment, the cleaving arrangement is used without lenses.

In one embodiment, shown in FIGS. 11 and 12, the output optical fiber 1105 and the input optical fiber 1110 are substantially parallel (i.e., touching or within 0.25 fiber diameters) throughout their lengths and are jointly terminated at their distal ends by a single ball 1115 formed by melting the two fiber ends together. In one embodiment, the ball is formed by laying the two fibers side by side and then melting the two fiber ends with the plasma discharge from an electric arc. In particular, in one embodiment, the following process is followed to form the single ball 1115:
a. The coating is removed off the ends of the fibers for a distance of approximately 40 mm (i.e., enough to perform the remaining elements of the process).
b. The fibers are cleaned.
c. The end of the fibers are cleaved (removes approximately 15 mm of fiber).
d. The two fibers are mounted next to each other (i.e., with their lengths near the cleaned and cleaved ends approximately parallel), in a vertical position, with their cleaned and cleaved ends at approximately the same location.
e. The end of the fibers are melted simultaneously using a time sequence of plasma arcs at an arc location. The fibers are exposed to the plasma arcs for a sufficient time to form the ball, i.e., typically 0.1 to 2.0 seconds for each arc. In one embodiment, the fibers are fed into a ball-forming location near, typically above, the arc location as the fibers are melted so that the ball forms and hangs from the fibers at the ball-forming location.

In one embodiment, the fiber ends are not melted together into a ball 1115 as shown in FIGS. 11 and 12. Instead, a single separate lens (not shown) is used.

In one embodiment, a computer program for controlling the operation of one or the systems shown in FIG. 1, 2, or 3 is stored on a computer readable media 1305, such as a CD or DVD, as shown in FIG. 13. In one embodiment a computer 1310, which may be the same as computer in the surface equipment 130 (FIG. 1), data gathering computer 215 (FIG. 2), or the computer 340 (FIG. 3), or a computer located below the earth's surface, reads the computer program from the computer readable media 1305 through an input/output device 1315 and stores it in a memory 1320 where it is prepared for execution through compiling and linking, if necessary, and then executed. In one embodiment, the system accepts inputs through an input/output device 1315, such as a keyboard, and provides outputs through an input/output device 1315, such as a monitor or printer. In one embodiment, the system stores the results of calculations in memory 1320 or modifies such calculations that already exist in memory 1320.

In one embodiment, the results of calculations that reside in memory 1320 are made available through a network 1325 to a remote real time operating center 1330. In one embodiment, the remote real time operating center 1330 makes the results of calculations available through a network 1335 to help in the planning of oil wells 1340, in the drilling of oil wells 1340, or in production of oil from oil wells 1340. Similarly, in one embodiment, the systems shown in FIG. 1, 2, or 3 can be controlled from the remote real time operating center 1330.

The word “couple” or “coupling” as used herein shall mean an electrical, electromagnetic, or mechanical connection and a direct or indirect connection.

In addition to power being provided from the surface through wireline cable 225, power may also be provided by a battery located in the wireline logging toolstring 235. Similarly, the downhole equipment in the MWD/LWD system shown in FIG. 3 may be powered by a downhole battery.

The text above describes one or more specific embodiments of a broader invention. The invention also is carried out in a variety of alternate embodiments and thus is not limited to those described here. The foregoing description of the preferred embodiment of the invention has been presented for the purposes of illustration and description. It is not intended to be exhaustive or to limit the invention to the precise form disclosed. Many modifications and variations are possible in light of the above teaching. Further, the device and system described herein is not limited in use to oil and gas applications. It can be used in any application in which Fabry-Pérot or Fizeau interferometers have application or in any application in which optical fibers are used to carry interrogating signals. It is intended that the scope of the invention be limited not by this detailed description, but rather by the claims appended hereto.

1. A system comprising:
an optical source;
a reflective sensor remotely deployed from the optical source;
an optical processor;
a forward optical waveguide spanning the distance from, and transmitting light from, the optical source to the reflective sensor;
a return optical waveguide spanning the distance from, and transmitting light from, the reflective sensor to the optical processor; and
the forward optical waveguide following substantially the same path as, but being completely separate from, the return optical waveguide.

2. The system of claim 1 further comprising:
a forward lens for projecting light from the forward optical waveguide onto the reflective sensor; and
a return lens for receiving light from the reflective sensor into the return optical waveguide.

3. The system of claim 2 wherein one of the forward lens and the reverse lens is a graded-index lens.

4. The system of claim 2 wherein:
the forward lens and the return lens are the same lens.

5. The system of claim 2 wherein:
the forward optical waveguide comprises a first optical fiber having a distal end proximate to the reflective sensor;
the return optical waveguide comprises a second optical fiber having a distal end proximate to the reflective sensor; and
the forward lens and the return lens are the same lens formed by melting together the distal end of the first optical fiber and the distal end of the second optical fiber into a single ball.

6. The system of claim 2 wherein:
the forward optical waveguide comprises a first optical fiber having a distal end proximate to the reflective sensor;
the return optical waveguide comprises a second optical fiber having a distal end proximate to the reflective sensor;
the forward lens is formed by melting the distal end of the first optical fiber into a forward ball; and
the reverse lens is formed by melting the distal end of the second optical fiber into a reverse ball.

7. The system of claim 6 wherein the forward ball is smaller than the reverse ball.

8. The system of claim 2 wherein:
the forward optical waveguide comprises a first optical fiber having a distal end proximate to the reflective sensor;
the return optical waveguide comprises a second optical fiber having a distal end proximate to the reflective sensor;
the distal end of the first optical fiber is cleaved; and
the distal end of the second optical fiber is cleaved.

9. The system of claim 1 wherein:
the forward optical waveguide comprises an optical fiber selected from the group consisting of a single mode fiber and a multimode optical fiber; and
the return optical waveguide comprises an optical fiber selected from the group consisting of a single mode fiber and a multimode optical fiber.

10. The system of claim 1 wherein:
the reflective sensor comprises a Fabry-Perot sensor.

11. The system of claim 1 wherein:
the optical source comprises a fiber to which the forward optical waveguide and return optical waveguide are coupled.

12. The system of claim 1 wherein:
the optical source is located downhole in a well.

13. The system of claim 1 wherein:
the optical source is located downhole in a well; and
the optical processor is located downhole in the well.

14. A device comprising:
a forward optical fiber having a distal end;
a return optical fiber, the return optical fiber being substantially parallel to the forward optical fiber and having a distal end;
a lens formed by melting together the distal end of the forward optical fiber and the distal end of the return optical fiber into a single ball.

15. The device of claim 14 wherein:
the forward optical fiber comprises a first multimode optical fiber; and
the return optical fiber comprises a second multimode optical fiber.

16. A method for manufacturing a device comprising:
laying out a forward optical fiber having a distal end;
laying out a return optical fiber having a distal end, such that a segment of the forward optical fiber at its distal end is substantially parallel to a segment of the return optical fiber at its distal end; and
melting together a distal end of the forward optical fiber and a distal end of the return optical fiber into a single ball to form a lens.

17. A system comprising:
an optical source;
a first reflective sensor remotely deployed from the optical source;
a second reflective sensor remotely deployed from the optical source;
an optical processor;
a forward optical waveguide spanning the distance from, and transmitting light from, the optical source to the first reflective sensor;
a linking optical waveguide spanning the distance from, and transmitting light from, the first reflective sensor to the second reflective sensor; and
a return optical waveguide spanning the distance from, and transmitting light from, the second reflective sensor to the optical processor.

18. The system of claim 17 wherein:
the first reflective sensor is adjusted to respond to the light from the optical source in a way that is distinguishable from the response of the second reflective sensor to the light from the optical source.

19. The system of claim 17 wherein:
the first reflective sensor comprises a Fabry-Pérot sensor having a first reflective sensor window located a distance δ1 from a first reflective sensor mirror and generating a first interference pattern in response to the light from the light source;
the second reflective sensor comprises a Fabry-Pérot sensor having a second reflective sensor window located a distance δ2 from a second reflective sensor mirror and generating a second interference pattern in response to the light from the light source; and
δ1 is sufficiently different from δ2 so that the optical processor can distinguish the first interference pattern from the second interference pattern.

20. The system of claim 17 wherein:
the optical processor distinguishes light reflected from the first reflective sensor from the light reflected from the second reflective sensor.

21. The system of claim 17 wherein the first reflective sensor is remotely deployed from the second reflective sensor.
